(19) United States
(12) Patent Application Publication
(10) Pub. No.: US 2022/0017653 A1
(43) Pub. Date: Jan. 20, 2022

(54) SOLUTION POLYMERIZATION PROCESS

(71) Applicant: Dow Global Technologies LLC, Midland, MI (US)

(72) Inventors: Alec Y. Wang, Sugar Land, TX (US); Jorge Rubalcaba, Pearland, TX (US); Michael D. Turner, Sugar Land, TX (US); Michael J. Zogg, Jr., Houston, TX (US); Pradeep Jain, Missouri City, TX (US)

(21) Appl. No.: 17/312,723

(22) PCT Filed: Dec. 13, 2019
(86) PCT No.: PCT/US2019/066275

§ 371 Date: Jun. 10, 2021

Related U.S. Application Data
(60) Provisional application No. 62/779,589, filed on Dec. 14, 2018.

(51) Int. Cl. C08F 2/01; C08F 10/02; C08F 2/06; C08F 6/10; C08K 5/01; B01J 19/18

(52) U.S. Cl. CPC C08F 2/01; C08F 10/02; C08F 2/06; B01J 2219/00162; C08K 5/01; B01J 19/18; B01J 2219/00159; C08F 6/10

(57) ABSTRACT

Disclosed herein is a system for solution polymerization comprising a reactor system that is operative to receive an anti-solvent, a monomer, and a solvent, and to react the monomer to form a polymer; where the anti-solvent is not a solvent for the polymer and is operative to reduce the lower critical solution temperature; a plurality of devolatilization vessels located downstream of the reactor system, where each devolatilization vessel operates at a lower pressure than the preceding devolatilization vessel and wherein the plurality of devolatilization vessels receives a polymer solution from the reactor system; and a liquid-liquid separator that is operative to receive a polymer solution from the reactor system and to facilitate a separation between the polymer and volatiles by reducing the pressure and temperature of the polymer solution in the liquid-liquid separator.

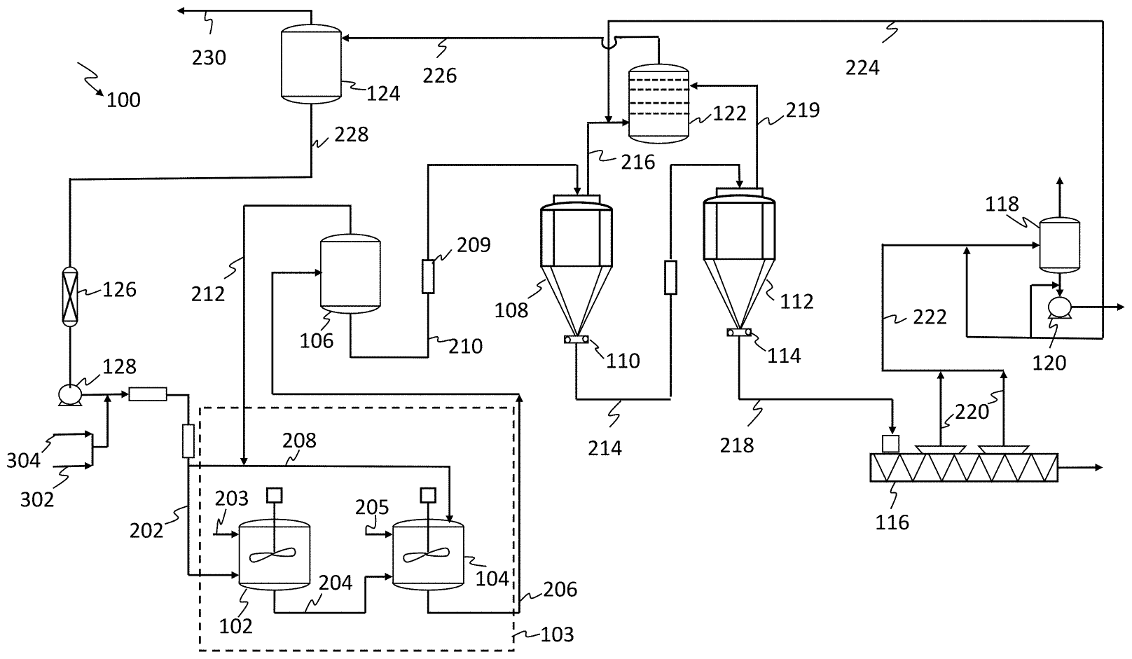

### CROSS REFERENCE TO RELATED APPLICATIONS

This application claims the benefit of U.S. Application No. 62/779,589, filed on Dec. 14, 2018, which is incorporated herein by reference in its entirety.

### BACKGROUND

This disclosure relates to a solution polymerization process. In particular, this disclosure relates to a solution polymerization process that is integrated with an upstream ethylene plant that uses a mixture of a solvent and a non-solvent.

A polymer solution can exhibit Lower Critical Solution Temperature (LCST) phenomenon, whereby a homogeneous polymer solution separates into a polymer rich liquid phase and a solvent-rich phase above a certain temperature. This temperature is a function of solvent type, polymer stream composition and pressure. Any of these variables can be manipulated to a induce liquid-liquid separation. This separation has very small heat duty associated with it, especially compared to the vaporization of an equivalent amount of solvent. In commercial solution polymerizations, there is a need to increase efficiency and reduce costs associated with solvent removal processes.

U.S. Pat. No. 6,881,800 to Friedersdorf relates to processes and plants for continuous solution polymerization. The plant includes a pressure source; a polymerization reactor, downstream of said pressure source; a pressure let-down device located downstream of the polymerization reactor; and a separator that is located downstream of the pressure let-down device. The pressure source is disclosed as sufficient to provide pressure to the reaction mixture during polymerization to produce a single-phase liquid reaction mixture in the reactor, and a two-phase liquid-liquid reaction mixture in the separator, in the absence of an additional pressure source between the reactor and the separator. This process discloses the use of a heater to heat the reactor outlet stream, prior to inducing liquid-liquid phase separation. Since the solution coming out of the reactor has more solvent per pound of polymer than that coming out of the separator, heating prior to the separator significantly increases the heat duty per pound of polymer.

International Publication No. WO 2008/076589 to Friedersdorf et al. discloses a process for polymerizing olefins in a dense fluid, homogeneous polymerization system. The process comprises (a) contacting, in one or more reactors, olefin monomers having three or more carbon atoms present at 30 weight percent, or more, with the following: 1) one or more catalyst compounds, 2) one or more activators, 3) from 0 to 50 mole percent comonomer, and 4) 0 to 40 weight percent diluent or solvent; (b) forming a reactor effluent comprising the polymer-monomer mixture; (c) optionally heating the polymer-monomer mixture of (b), after it exits the reactor, and before, or after, the pressure is reduced in step (e); (d) collecting the polymer-monomer mixture of (b) in a separation vessel; (e) reducing the pressure of the reactor effluent comprising the polymer-monomer mixture of (b) below the cloud point pressure to form a two-phase mixture comprising a polymer-rich phase and a monomer rich phase, either before, or after, collecting the polymer-monomer mixture in the separation vessel. The pressure in the reactor is from 7 to 100 MPa higher than the pressure in the separation vessel, and the temperature in the separation vessel is above the higher of the crystallization temperature of the polymer, or above 80° C., if the polymer has no crystallization temperature. The monomer-rich phase is separated from the polymer-rich phase, and recycled to one or more reactors. This patent discloses that a reactor pressure used to run this process with less than 40 weight percent solvent is high (up to 200 MPa), to ensure a supercritical polymerization medium. This high pressure makes the reactor operation challenging, and necessitates the use of thick walled reactors which reduced capital and energy efficiency.

U.S. Pat. No. 6,255,410 to Shigekauzu et al. discloses a process for producing polyolefins at pressures substantially below conventional high pressure conditions in two-phase systems. The process comprises (a) continuously feeding olefinic monomer and catalyst system of metallocene and cocatalyst; (b) continuously polymerizing the monomer feed to provide a monomer-polymer mixture; and (c) continuously settling a two phase mixture into a continuous molten polymer phase and a continuous monomer vapor, the latter of which may, optionally, be at least partly recycled to (a). In (b), the mixture is at a pressure below the cloud point pressure to provide a polymer-rich phase and a monomer-rich phase at a temperature above the melting point of the polymer, and the polymerization takes place at a temperature and a pressure, where the catalyst system productivity exceeds that which is obtained at twice the pressure above the cloud point at that temperature. This patent discloses only minor amounts of solvent, as required for a catalyst carrier, and does not have the advantages of using lower temperatures and pressures associated with solution polymerization processes.

The polymerization processes described in the above references are typically energy intensive, requiring heat exchanges between the polymerization reactor and the separator, supercritical polymerization conditions, and/or additional polymer-solvent separation means. There is a need to develop new polymerization processes that use solvent separation means that utilize less energy and have increased efficiency and reduced costs. There is also a need to eliminate ancillary and energy intensive devices thereby reducing capital and operating costs.

### SUMMARY

Disclosed herein is a system for solution polymerization comprising a reactor system that is operative to receive an anti-solvent, a monomer, and a solvent, and to react the monomer to form a polymer; where the anti-solvent is not a solvent for the polymer and is operative to reduce the lower critical solution temperature; a plurality of devolatilization vessels located downstream of the reactor system, where each devolatilization vessel operates at a lower pressure than the preceding devolatilization vessel and wherein the plurality of devolatilization vessels receives a polymer solution from the reactor system; and a liquid-liquid separator that is operative to receive a polymer solution from the reactor system and to facilitate a separation between the polymer and volatiles by reducing the pressure and temperature of the polymer solution in the liquid-liquid separator, with the polymer is present in a polymer-rich phase and the volatiles are present in a solvent-rich phase.

Disclosed herein too is a method comprising charging to a reactor system a feed stream comprising an anti-solvent, a monomer, and a solvent; where the anti-solvent is not a solvent for the polymer and is operative to reduce the lower critical solution temperature of a polymer solution; reacting the monomer to form a polymer; where the polymer is contained in the polymer solution; transporting the polymer solution phase to a liquid-liquid separator; reducing a pressure of the polymer solution in the liquid-liquid separator and separating a polymer-rich phase from a solvent-rich phase in a liquid-liquid separator; transporting the polymer-rich phase to a plurality of devolatilization vessels located downstream of the liquid-liquid separator, where each devolatilization vessel operates at a lower pressure than the preceding devolatilization vessel; and separating the polymer from volatiles present in the polymer rich phase.

### BRIEF DESCRIPTION OF THE FIGURES

The FIGURE depicts an exemplary embodiment of the system used to solution polymerize monomers in a solution that contains an anti-solvent.

### DETAILED DESCRIPTION

The term “continuous stirred-tank reactor,” or “CSTR,” as used herein, refers to a tank reactor to which reactants are continuously fed and product is continuously withdrawn. The CSTR is mechanically agitated such that there is a close approximation of perfect back mixing.

The term “boiling reactor,” as used herein, refers to a reactor operated at conditions such that both a liquid phase and a vapor phase are present. At least part of the solvent and monomer introduced into the reactor as a liquid are vaporized and exit the reactor as a vapor, thereby removing part of the heat of polymerization which results in a higher polymer concentration, as compared to an adiabatic reactor, in the liquid stream that exits the reactor. The vapor stream that exits the reactor is cooled and recycled to the reactor. Any liquid that is condensed in this cooling process is also recycled to the reactor. These reactors are typically well mixed and can be mixed simply by the introduction of the vapor recycle stream; however the mixing can be augmented by means of mechanical agitation. The boiling reactor can be used by itself or in combination with other boiling reactors, CSTRs, loop reactors, or any other reactor for making polyolefins, and can be a single or multi-stage reactor.

A variation of the CSTR is the loop reactor which comprises a conduit through which process fluids are recirculated. Often it also contains one or multiple heat exchangers, a recirculation pump, and an injection device for reactants and catalyst. The heat exchangers in the loop reactors can be shell and tube, shell and tube with mixing element inserts, plate and frame, or flat plate type exchangers.

The term “tubular reactor” is meant to describe a reactor that is in the shape of a simple tube. The tubular reactor of this invention will have a length/diameter (L/D) ratio of at least 10/1. The tubular reactor may or may not be agitated. The tubular reactor may be operated adiabatically or isothermally. When operated adiabatically, as polymerization progresses, the remaining comonomer is increasingly consumed and the temperature of the solution increases (both of which improve the efficiency of separating the remaining comonomer from the polymer solution). It is especially preferred that the temperature increase along the length of the tubular reactor is greater than 3° C. (i.e., that the discharge temperature from the tubular reactor is at least 3° C. greater than the discharge temperature from the reactor that feeds the tubular reactor).

The tubular reactor used in this disclosure may have a feed port for additional ethylene, hydrogen, and solvent. The feed may be “tempered”—i.e., the temperature of the additional ethylene, hydrogen, and/or solvent is heated to above ambient (preferably to about 100° C.) but the temperature is below the discharge temperature of the tubular reactor. In an embodiment, the ethylene is tempered to between 100 and 200° C. It is also desirable to add the ethylene and hydrogen with solvent. The amount of solvent (expressed as a weight ratio, based on ethylene) is preferably from 10/1 to 0.1/1, especially from 5/1 to 1/1.

The term “adiabatically flashed,” as used herein, refers to a flashing step in which no heat is added to the polymer solution between the reactor or reactors and the flashing vessel.

By “substantially uniform,” as used with respect to a dimension (such as width or height) or a cross-sectional area of zone within a heating channel, is meant that the same is either not converging nor diverging at all, or is converging and/or diverging by no more than ten percent of the average of that dimension.

The term “solids content” refers to the amount of polymer in the polymer solution. The term “polymer concentration” is used interchangeably with “solids content” when referring to the concentration of the polymer in the polymer solution.

“Polymer” refers to a compound prepared by polymerizing monomers, whether of the same or a different type of monomer. The generic term “polymer” embraces the terms “oligomer,” “homopolymer,” “copolymer,” “terpolymer” as well as “interpolymer.”

“Interpolymer” refers to polymers prepared by the polymerization of at least two different types of monomers. The generic term “interpolymer” includes the term “copolymer” (which is usually employed to refer to a polymer prepared from two different monomers) as well as the term “terpolymer” (which is usually employed to refer to a polymer prepared from three different types of monomers). It also encompasses polymers made by polymerizing four or more types of monomers.

“Oligomer” refers to a polymer molecule consisting of only a few monomer units, such as a dimer, trimer, tetramer or a polymer with fewer than 20 carbon atoms in its chain.

Alpha-olefins (or α-olefins) are a family of organic compounds which are alkenes (also known as olefins) with a chemical formula CₓH₂ₓ, distinguished by having a double bond at the primary or alpha (a) position.

“Bubble point pressure” means the pressure at which the first bubble of vapor is formed at a given temperature.

“Polymer solution” means a solution containing a dissolved polymer where the polymer and the volatiles are in a single phase—a liquid phase.

Solution viscosities are measured using an Anton Paar MCR 102 rheometer made by Anton Paar Germany GmbH. The rheometer is equipped with a C-ETD300 electrical heating system. The cup-and-bob system (combination of concentric cylinders) comprises a 27 mm diameter cup and a 25 mm diameter bob to allow for 1 mm gap between the two. The bob is operated in rotational mode inside a 150 bar (approximately 153 kgf/cm²)-pressure cell. Viscosity measurements are obtained at a pressure of 30 bar ((approximately 31 kgf/cm²—obtained with a nitrogen atmosphere), a range of temperatures (150 to 250° C.), a range of polymer concentrations (20 to 90 weight percent), a range of shear rates (0.1 to >100 reciprocal seconds (s⁻¹)), and range of polymer molecular weights (15,000 to 200,000 g/mole). The solvent in all cases was ISOPAR™ E by ExxonMobil. The viscosity measurements obtained ranged from 100 to greater than 2,000,000 centipoise.

Disclosed herein is a process for the solution polymerization of α-olefins. The process includes conducting a homogenous polymerization of α-olefins in a hydrocarbon solvent using one or two high-pressure agitated adiabatic reactors to make designed polyethylene and elastomers products. The reactors are operated at low conversion conditions and uses a mixture of monomer and anti-solvent to reduce the lower critical solution temperature (LCST) of the system. In a preferred embodiment, the monomer is ethylene and the anti-solvent is ethane. An anti-solvent is a liquid in which the polymer (e.g., the polyolefin) is less soluble and more preferably in which the polymer is insoluble.

This integrated ethane and ethylene feed stream helps eliminate a costly “de-ethane” step in the ethylene plant (hydrocarbon plant) to separate ethylene from ethane. This process can be used for making olefin-based polymers, such as ethylene homopolymers, or interpolymers with other alkenes (for example, copolymers or terpolymers), and, optionally, a diene (for example an EPDM terpolymer).

Disclosed herein too is a system in which the solution polymerization of the α-olefins is conducted. The system comprises one or more reactors in which the α-olefins are polymerized in a solvent system that comprises an anti-solvent (e.g., ethane). In an embodiment, the system comprises a plurality of reactors in series with one another that are used for solution polymerization of one or more monomers to produce a polymer-solvent solution (hereinafter termed a polymer solution). At least one of the reactors facilitates the polymerization under adiabatic conditions. The reactors are in fluid communication with a liquid-liquid separator and a devolatilization system that comprises at least 1 devolatilization vessel, preferably at least 2 devolatilization vessels. Each successive devolatilization vessel operates at a lower pressure than the preceding vessel. This arrangement increases the solids content in the polymer stream to at least 92 wt % prior to pelletization, granulation and solidification.

The FIGURE is a schematic depiction of an exemplary solution polymerization system 100 (hereinafter system 100) that may be used to polymerize a monomer (or a plurality of monomers) to produce a polymer or copolymer. The system 100 comprises a reactor system 103 which can comprise a one or more reactor units (that are arranged either in series or in parallel) in fluid communication with each other. An example of such a reactor system is presented in U.S. Pat. Nos. 4,616,937, 4,753,535 and 4,808,007, the entire contents of which are hereby incorporated by reference.

The reactor system 103 is operative to receive monomers, comonomers, hydrogen, catalyst, initiator, solvent, and the like. In an embodiment, the reactors in the reactor system may be continuous stirred tank reactors (CSTRs), loop reactors (e.g., single loop reactor, double loop reactor), boiling reactors, and can be single or multi-stage reactors. In an embodiment, this process may employ multiple catalysts in one or more reactors.

In an embodiment, when the reactor system employs multiple reactors, these reactors may all be the same type (e.g., all reactors may be loop reactors or all reactors may be continuous stirred tank reactors). In another embodiment, the reactors may be different reactor types (e.g., one reactor may a loop reactor while the other reactor may be a continuous stirred tank reactor) or combinations thereof. In an embodiment, at least one of the reactors is an adiabatic reactor, i.e., no heat is supplied to the reactor during the reaction.

With reference now again to the FIGURE, the reactor system 103 comprises two reactors—a first reactor 102 and a second reactor 104 that are in series with each other. In a preferred embodiment, the first reactor 102 and the second reactor 104 are both continuous stirred tank reactors. Both reactors are operated under adiabatic conditions. Details of the reactor operation are detailed later.

Located downstream of the reactor system 103 are a plurality of devolatilization vessels in series with one another—a first devolatilization vessel 110 and a second devolatilization vessel 112 that are in fluid communication with the reactor system and with one another. Disposed between the reactor system 102 and the first devolatilization vessel 108 is a liquid-liquid separator 106 that is operative to separate some of the solvent and unreacted monomer from the polymer. The liquid-liquid separator 106 increases the polymer concentration by evaporating some of the solvent and unreacted monomer and discharging it to the reactor system 103 via stream 212.

A positive displacement pump that facilitates transport of the polymer solution from the devolatilization vessel is located downstream of each of the devolatilization vessels. A first positive displacement pump 110 is located downstream of the first devolatilization vessel 110 with a second positive displacement pump 114 being located downstream of the second devolatilization vessel 112.

In an embodiment, the pumps 110 and 114 are both screw pumps. In another embodiment, the pumps 110 and 114 are both gear pumps. The polymer solution discharged from the second pump 114 is charged to an extruder 116 where the polymer solution now substantially devoid of solvent is pelletized. Solvent and unreacted monomer extracted at the extruder is recycled and charged to the reactor system 103 via condensers 120 and 122.

In an embodiment, in one manner of utilizing the system 100 to produce olefin polymers, α-olefin monomers are charged to the reactor system 103 along with catalyst, initiator, solvents and hydrogen. The reactants such as the α-olefin monomers along with the ethane is introduced into the reaction system 103 via stream 302, while hydrogen is simultaneously introduced into the reaction system 103 via stream 304.

In an embodiment, the α-olefin monomer may comprise only ethylene. In another embodiment, the α-olefin monomer may comprise ethylene along with an α-olefin comonomer that has 3 to 12 carbon atoms. Illustrative examples of such alpha-olefin comonomers are one or more of propylene, 1-butene, 1-pentene, 1-hexene, 1-octene and 1-decene. 1-octene is preferred.

The feed solvent in addition to solubilizing the polymer serves as heat sink to absorb the heat of reaction. Examples of inert hydrocarbon solvents include a C₅₋₁₂ hydrocarbon which may be unsubstituted or substituted by a C₁₋₄ alkyl group such as pentane, methyl pentane, hexane, heptane, octane, cyclohexane, methyl cyclohexane, hydrogenated naphtha, or a combination thereof. A preferred solvent is methyl cyclohexane,

The weight ratio of solvent to monomer in the stream 202 (which feeds the reactants to the reactor system 103) is 5 to 10. In a preferred embodiment, the weight ratio of solvent to monomer in the stream 202 is 6 to 8.

In an embodiment, the solvent contains an anti-solvent (i.e., the solvent comprises two or more fluids, one of which is not compatible with the polymer being manufactured). The anti-solvent is an alkane. The anti-solvent is preferably ethane. Other anti-solvent alkanes such as propane, butane, hexane, and the like, may be also used in lieu of ethane or in conjunction with ethane. In a preferred embodiment, the process takes advantage of the feed stream from the hydrocarbon plant that “naturally” has ethane and ethylene. The presence of ethane facilitates a reduction of the lower critical solution temperature (LCST) of the system. The advantage of combining ethane with the α-olefin feed at stream 302 is that it (the ethane) facilitates the separation of ethylene from ethane by reacting the ethylene in the ethane/ethylene stream, thus reducing the capital expenditure and operating cost for the upstream ethylene plant. Ethane acts as an anti-solvent by reducing the LCST of the solution and thus facilitates effective liquid-liquid separation without the need to pre-heat the reactor effluent stream.

The weight ratio of anti-solvent to the solvent in the stream 202 is 1 to 10. In a preferred embodiment, the weight ratio of anti-solvent to solvent in the stream 202 is 1 to 5.

The monomers are mixed with hydrogen and dissolved/dispersed in the solvent (and the anti-solvent) prior to being fed to the reactor system 103. Prior to mixing, the solvent and monomers (sometimes referred to as “feedstock”) are generally purified to remove potential catalyst poisons such as water, oxygen, or other polar impurities. The feedstock purification may employ molecular sieves, alumina beds or oxygen removal catalysts. The solvent may also be purified in a similar manner. The feeds to the reactor system 103 are generally cooled down to a temperature of less than 40° C., preferably less than 20° C. The cooling of the feed can facilitate a reduction in heat exchanger size in the reactor system. The cooling can be conducted either in the reactor system or prior to entry into the reactor system. In a preferred embodiment, the cooling of the feed can be conducted prior to entry into the reactor system.

In an embodiment, the catalyst may be premixed in the solvent for the reaction or fed as separate streams to one or multiple reactors in the reactor system 103. In an embodiment, some or all of the catalyst is introduced into the first reactor 102 via stream 203, while additional catalyst may be added to the second reactor 104 via stream 205. Catalysts used can be Ziegler-Natta catalysts, bis-metallocene catalysts, constrained geometry catalysts, a polyvalent aryloxyether complex, a phosphinimine, or a combination thereof.

In an embodiment, the first reactor 102 operates at a pressure of greater than or equal to 90 kgf/cm², preferably greater than or equal to 95 kgf/cm², and more preferably greater than or equal to 100 kgf/cm². In an embodiment, the first reactor 102 operates at a pressure of less than or equal to 200 kgf/cm², preferably less than or equal to 195 kgf/cm², and more preferably less than or equal to 180 kgf/cm². In a preferred embodiment, the first reactor 102 operates at a pressure of 145 kgf/cm² to 165 kgf/cm². In an embodiment, the first reactor 102 operates at temperatures ranging from 120 to 230° C. In an embodiment, the polymer solution exiting the first reactor 102 can have temperatures of 130 to 240° C., preferably 150 to 170° C.

The polymer (solids content) is present in the polymer solution in an amount of 8 to 16 wt %, preferably 9 to 15 wt %, and more preferably 11 to 13 wt %, at the exit of the first reactor 102. The weight percent (wt %) is based on the total weight of the polymer stream. Melt indices I₂ (or I2) and I₁₀ (or I10), for ethylene-based polymers, are measured in accordance with ASTM D-1238 (method B) at 190° C. and at 2.16 kg and 10 kg load, respectively. Their values are reported in g/10 min. The melt index ratio (also called a melt flow ratio) I₁₀/I₂ is the ratio of the two values and it is dimensionless. The melt index ratio of the polymer at the exit of the first reactor 102 can range from 0.1 to 1,500.

In an embodiment, the viscosity of the polymer solution exiting the first reactor 102 is 50 to 6,000 centipoise when measured as detailed above. Samples for density measurement are prepared according to ASTM D4703. Measurements are made, according to ASTM D792, Method B, within one hour of sample pressing.

In an exemplary embodiment, the product exiting the first reactor 102 has density of 0.865 to 0.920 g/cm³, a melt index I₂ of 0.25 to 210.0, and a melt flow ratio of I₁₀/I₂ of 6.0 to 8.5. At a reactor temperature of 160° C. and polymer concentration of 12 wt %, the solution viscosity at the reactor system exit is expected to be over 350 centipoise, measured as detailed above.

The second reactor 104 operates at a higher temperature than the first reactor 102. In an embodiment, the second reactor operates at a lower pressure than the first reactor 102. The second reactor 104 is operative to increase the solids content in the polymer stream by an amount of more than 10 wt %, preferably more than 15 wt %, preferably more than 20 wt %, and more preferably more than 25 wt %, relative to the solids content of the polymer stream emanating from the first reactor 102. In an embodiment, the solids content emanating from the second reactor 104 is 12 to 20 wt %, preferably 14 to 18 wt %, and more preferably 15 to 17 wt %, based on the total weight of the polymer stream.

In an embodiment, the second reactor 104 operates at a lower pressure than the first reactor 102. The second reactor 104 operates at a pressure of greater than or equal to 80 kgf/cm², preferably greater than or equal to 85 kgf/cm², and more preferably greater than or equal to 90 kgf/cm². In an embodiment, the second reactor 104 operates at a pressure of less than or equal to 180 kgf/cm², preferably less than or equal to 175 kgf/cm², and more preferably less than or equal to 170 kgf/cm². In a preferred embodiment, the second reactor 102 operates at a pressure of 130 kgf/cm² to 143 kgf/cm².

The second reactor 104 operates at a higher temperature than the first reactor. The second reactor has a temperature that is at least 25% higher, preferably at least 30% higher and more preferably at least 35% higher than the temperature of the first reactor 102. In an embodiment, the second reactor 104 operates at a temperature ranging from 190 to 250° C. In an embodiment, the polymer solution exiting the second reactor 102 can have temperatures of 200 to 240° C., preferably 210 to 230° C., and more preferably 218 to 224° C.

In an embodiment (not shown), the activity of the polymer solution may be terminated or reduced substantially by adding a catalyst neutralizer (sometimes referred to as a hydrolyzer) to the polymer solution at a port (not shown) located in the stream 206 (located downstream of the reactor system 103). The catalyst neutralizer serves to reduce the catalyst activity to as close to zero as possible. An example of a catalyst neutralizer is water or alcohol and it is added to the polymer solution in an amount of 10 to 100 parts per million, based on the total weight of the polymer that is in solution.

The polymer solution is then transferred from the reactor system 103 to the liquid-liquid separator 106. The pressure of the polymer solution from the second reactor is reduced to below 92 kgf/cm² in the liquid-liquid separator from the outlet pressure of the second reactor 104 (which is 130 kgf/cm² to 143 kgf/cm²). The presence of ethane, which is a component of the feed stream to the reactor system 103, effectively reduces the system lower critical solution temperature (LCST) to approximately 193° C., which is the lowest temperature to induce liquid-liquid separation.

The liquid-liquid separator facilitates a separation of the polymer from the volatiles by reducing the pressure, temperature, or both the pressure and the temperature of the polymer solution. In other words, the use of ethane facilitates a separation of the polymer from the volatiles without any expenditure of energy. Put another way, the temperature and pressure of the polymer solution is not increased as the polymer solution is transported from the reactor system to the liquid-liquid separator.

With the second reactor operating at least 220° C., the reactor effluent (i.e., the polymer solution) is above the system lower critical solution temperature that is capable of inducing liquid-liquid separation without any additional energy input. By reducing the pressure to below 92 kgf/cm² in the liquid-liquid separator, liquid-liquid separation is facilitated, since the polymer solution is displaced into the liquid-liquid regime, but remains above the bubble point pressure of the system (which is approximately about 70 kgf/cm². The displacement of the polymer solution below the lower critical solution temperature promotes the polymer solution to separate into a solvent-rich phase and a polymer-rich phase. The polymer-rich phase segregates to the bottom of the liquid-liquid separator, while the solvent-rich phase lies atop the polymer-rich phase. The polymer-rich phase is removed from the bottom of the liquid-liquid separator and transported to the first devolatilization vessel 108 via stream 210. In an embodiment, the stream 210 emanating from the liquid-liquid separator has at least 25% more solids than the stream 206 emanating from the second reactor 104. Stream 210 contains 20 to 24 wt % solids, based on the total weight of the polymer solution removed from the bottom of the separator.

The solvent-rich phase is removed via stream 212 and is recycled into the reactor system 103 via stream 208. In an embodiment, the solvent-rich phase is recycled to the second reactor 104. As no polar compounds are introduced into the polymer stream prior to the liquid-liquid separator, the solvent-rich stream exiting the liquid-liquid separator can be sent back to the reactor feed section directly without the need to put it through any additional purification steps.

In an embodiment, the reactivity of the resulting polymer-rich stream 210 is terminated using a heater 209 that is disposed downstream of the liquid-liquid separator and upstream of the first devolatilization vessel 108. Heater 209 (located along stream 210) increases the temperature of the polymer stream to at least 215° C., preferably at least 220° C. This increase in temperature in addition to terminating the reaction in the system 100 facilitates flashing of the solvent from the polymer solution, when the solution is introduced into the devolatilization system, which is described below.

The polymer solution is then discharged to a devolatilization system that comprises a series of devolatilization vessels—the first devolatilization vessel 108 and the second devolatilization vessel 112, both of which are in serial fluid communication with one another. The first devolatilization vessel 108 is located upstream of the second devolatilization vessel 112. Each sequential devolatilization vessel operates at a lower pressure than the preceding vessel and each devolatilization vessel facilitates adiabatic flashing of the solvent from the polymer solution, leaving behind a polymer solution that has a higher polymer concentration than that prior to the flashing.

The polymer solution comprises about 20 to 24 wt % solids, preferably 21 to 23 wt % solids at the point of entry into the first devolatilization vessel 108. In the first devolatilization vessel 108, the polymer solution is subjected to a flash where at least 60 wt % of the solvent is removed so that the solution is concentrated to at least 60 wt % polymer, preferably at least 65 wt %, based on the total weight of the polymer solution. In an embodiment, the flashing is conducted adiabatically.

In one embodiment, the first devolatilization vessel 108 operates adiabatically to facilitate solvent removal from the polymer solution. In one embodiment, the pressure in the first devolatilization vessel is maintained at 6 to 12 kgf/cm², preferably 8 to 10 kgf/cm², thus permitting the solvent to flash off and to increase the polymer content in the polymer solution to 45 to 90 wt %, preferably 50 to 70 wt %, based on the total weight of the polymer solution leaving the first devolatilization vessel via stream 214. In an embodiment, at least 50 wt %, preferably at least 55 wt % of the solvent present in the polymer solution (at the time of entry into the first devolatilization vessel 108) is flashed off. The flashed solvent is removed from the first devolatilization vessel 108 via line 216 to a condensation tank 122, from which it is recycled back to the reactor system 103 via streams 226 and 228.

The temperature of the polymer solution leaving the first devolatilization vessel 108 is 170° C. to 220° C. and its pressure is at 2 to 12 kgf/cm². The polymer solution exiting the first devolatilization vessel 108 contains polymer in an amount of 50 to 90 wt %, based on the total weight of the polymer solution that exits the first devolatilization vessel 108. In an embodiment, the solids content is increased to at least 60 wt % polymer, preferably at least 65 wt %, based on the total weight of the polymer solution leaving the first devolatilization vessel 108.

The polymer solution is then discharged from the first devolatilization vessel 108 via stream 214 to an optional first positive displacement pump 110. The optional first positive displacement pump 110 facilitates increasing the pressure of the polymer solution. This increase in the pressure (brought about by the first optional positive displacement pump 110) facilitates further devolatilization of volatiles (e.g., solvents and unreacted monomer) from the polymer solution when it is adiabatically flashed in the second devolatilization vessel 112 to increase the solids concentration to an amount greater than 90 wt %, preferably greater than 92 wt %, and more preferably greater than 95 wt %, based on the total weight of the polymer solution leaving the second devolatilization vessel 112.

The second devolatilization vessel 112 may also operate adiabatically to facilitate solvent removal from the polymer solution. In one embodiment, the polymer solution entering the second devolatilization vessel 112 (See the FIGURE) is at a temperature of 210 to 260° C., preferably 220 to 240° C. In one embodiment, the pressure in the second devolatilization vessel is maintained at 0.5 to 1 kgf/cm² permitting the solvent to flash off and to increase the solids content in the polymer solution to 90 to 97 wt %, preferably 92 to 95 wt %, based on the total weight of the polymer solution at the exit of the second devolatilization vessel 112. The temperature of the polymer solution leaving the second devolatilization vessel 112 is 180° C. to 240° C., preferably 190 to 230° C.

Volatiles removed from the flashing (of the polymer solution) in the second devolatilization vessel 112 is transported to the condensation vessel 122 via stream 219, from where it is recycled to the reactor system 103 via a solvent recovery vessel 124. Streams 226 and 228 facilitate the transport of the volatiles to the reaction system 103. A heat exchanger 126 and pump 128 are used to raise the temperature and pressure respectively of the volatile stream

A second positive displacement pump 114 facilitates charging the polymer solution (with a solvent content of less than 6 wt %, preferably less than 5 wt %) via stream 218 to a granulation and solidification device such as a pelletizer 116 where the polymer is pelletized and packaged for transportation.

Volatiles generated in the two devolatilization vessels 108 and 112 as well as volatiles generated in the pelletizer are transported to a solvent recovery vessel 124 and from there recycled to the reactor system 103. Volatiles from the first devolatilization vessel 108 are transported to the solvent recovery vessel 124 via stream 216 and condensation vessel 122. Volatiles from the second devolatilization vessel 112 are transported to the solvent recovery vessel 124 via stream 219 and condensation vessel 122. Volatiles from the pelletizer 116 are transported via stream 220, 222, 224, 226 and 228 to the solvent recovery vessel 124 and from there recycled to the reactor system 103.

The recycled volatiles along with the feed comprising ethylene and ethane (see stream 302) and hydrogen (see stream 304) are then fed via stream 202 to the reactor system 103. The reaction in the reactor system 103 proceed as detailed above.

The system disclosed herein is advantageous in that the addition of ethane as an anti-solvent reduces the lower critical solution temperature to a value that is sufficient to induce liquid-liquid separation without any need for additional energy. There is no need to pre-heat the reactor effluent stream in order to facilitate liquid-liquid separation. It is thus a cost effective and an energy efficient method.

1. A system for solution polymerization comprising:
a reactor system that is operative to receive an anti-solvent, a monomer, and a solvent, and to react the monomer to form a polymer; where the anti-solvent is not a solvent for the polymer and is operative to reduce the lower critical solution temperature;
a plurality of devolatilization vessels located downstream of the reactor system, where each devolatilization vessel operates at a lower pressure than the preceding devolatilization vessel and wherein the plurality of devolatilization vessels receives a polymer solution from the reactor system; and
a liquid-liquid separator that is operative to receive a polymer solution from the reactor system and to facilitate a separation between the polymer and volatiles by reducing the pressure and temperature of the polymer solution in the liquid-liquid separator, with the polymer is present in a polymer-rich phase and the volatiles are present in a solvent-rich phase.

2. The system of claim 1, where the anti-solvent is ethane, the monomer is an α-olefin and where the solvent is methylcyclohexane.

3. The system of claim 1, where the reactor system comprises a first reactor that operates at a temperature of 120° C. to 230° C. and a pressure of greater than or equal to 90 kgf/cm² to less than or equal to 200 kgf/cm².

4. The system of claim 3, where the solids content in the polymer solution is present in an amount of 8 to 16 wt %, based on a total weight of the polymer solution at the exit of the first reactor.

5. The system of claim 3, where the reactor system further comprises a second reactor that operates at a higher temperature and a lower pressure than the first reactor.

6. The system of claim 5, where the second reactor operates at a pressure of greater than or equal to 80 kgf/cm² to less than or equal to 180 kgf/cm² and a temperature of 200 to 240° C.

7. The system of claim 6, where the solids content in the polymer solution is present in an amount of 12 to 20 wt %, based on a total weight of the polymer solution at the exit of the second reactor.

8. The system of claim 1, where the pressure in the liquid-liquid separator is above the bubble point of the polymer solution.

9. The system of claim 1, where a pressure of the polymer solution in the liquid-liquid separator is reduced to 92 kgf/cm² from 180 kgf/cm² and where a solids content of the polymer solution emanating from the liquid-liquid separator is 20 to 24 wt %.

10. The system of claim 1, where the a plurality of devolatilization vessels comprises a first devolatilization vessel that is operative to increase solids content in the polymer stream to at least 60 wt % polymer, based on the total weight of the polymer solution leaving the first devolatilization vessel.

11. The system of claim 10, where the a plurality of devolatilization vessels further comprises a second devolatilization vessel that is operative to increase solids content in the polymer stream to at least 90 wt % polymer, based on the total weight of the polymer solution leaving the second devolatilization vessel.

12. The system of claim 1, where the volatiles generated in the plurality of devolatilization vessels are recycled back to the reactor system.

13. A method comprising:
charging to a reactor system a feed stream comprising an anti-solvent, a monomer, and a solvent; where the anti-solvent is not a solvent for the polymer and is operative to reduce the lower critical solution temperature of a polymer solution;
reacting the monomer to form a polymer; where the polymer is contained in the polymer solution;
transporting the polymer solution phase to a liquid-liquid separator;
reducing a pressure of the polymer solution in the liquid-liquid separator and separating a polymer-rich phase from a solvent-rich phase in a liquid-liquid separator;
transporting the polymer-rich phase to a plurality of devolatilization vessels located downstream of the liquid-liquid separator, where each devolatilization vessel operates at a lower pressure than the preceding devolatilization vessel; and
separating the polymer from volatiles present in the polymer rich phase.

14. The method of claim 13, further comprising pelletizing the polymer.

15. The method of claim 13, further comprising recycling volatiles to the reactor system.
